(19) United States
(12) Patent Application Publication
(10) Pub. No.: US 2011/0233141 A1
(43) Pub. Date: Sep. 29, 2011

(54) WASTEWATER TREATMENT SYSTEM AND METHODS FOR CONSTRUCTING THE SAME

(76) Inventor: John McLain, Golden, CO (US)

(21) Appl. No.: 12/730,943

(22) Filed: Mar. 24, 2010

(51) Int. Cl. C02F 1/00

(52) U.S. Cl. 210/747.9; 210/170.08

(57) ABSTRACT

A wastewater treatment system capable of reducing or eliminating point discharge. The wastewater treatment system includes a wastewater treatment unit and a wastewater treatment lagoon in fluid communication with the wastewater treatment unit. The wastewater treatment lagoon can be located at a higher elevation than the wastewater treatment unit. The wastewater treatment lagoon can preferably be a combined evaporation/infiltration lagoon. A drip irrigation system can also be included around the periphery of the wastewater treatment lagoon and in fluid communication with the wastewater treatment lagoon.

### BACKGROUND

Many municipalities use wastewater treatment lagoons to treat wastewater. A variety of wastewater treatment lagoons exist for treating wastewater in various ways. For example, larger waste particulates can be removed from wastewater using a settling wastewater treatment lagoon. Smaller waste particulates can be consumed by organisms living in the wastewater treatment lagoons. Regardless of the manner in which wastewater is treated in a wastewater treatment lagoon, many lagoons ultimately dispose of treated wastewater using a point discharge. Point discharge means that the treated water is deposited into a natural body of water, such as a river or stream, at a single location.

Point discharge can be regulated by local, state, and national environmental agencies. The United States Environmental Protection Agency is expected to further restrict point discharge in the near future by further limiting the amount of constituents that may be contained in treated wastewater that is point discharged into a natural body of water. Meeting these stringent restrictions may be become difficult or impossible through the use of wastewater treatment lagoons only. Ultimately, mechanical wastewater treatment facilities might become a necessary part of any wastewater treatment system that utilized point discharge. However, these mechanical wastewater treatment facilities can be expensive to construct and operate, and many municipalities lack the funds to incorporate mechanical wastewater treatment facilities that will help to meet the point discharge restrictions.

Accordingly, a need exists for wastewater treatment facilities that effectively treat wastewater but that can avoid either point discharge and the attendant restrictions and the need for expensive mechanical treatment systems.

### SUMMARY

In some embodiments, a wastewater treatment system is disclosed. The wastewater treatment system includes a wastewater treatment unit, a wastewater treatment lagoon in fluid communication with the wastewater treatment unit and located at a higher elevation that then wastewater treatment unit, a fluid pump capable of moving fluid from the wastewater treatment unit to the wastewater treatment lagoon, and a drip irrigation system located around the periphery of the wastewater treatment and in fluid communication with the wastewater treatment lagoon.

In some embodiments, a method of modifying a wastewater treatment system is disclosed. The method includes the steps of constructing an infiltration/evaporation wastewater treatment lagoon in the proximity of and at a higher elevation than an existing wastewater treatment unit, fluidly connecting the infiltration/evaporation wastewater treatment lagoon to the existing wastewater treatment unit, and providing a fluid pump capable of transporting fluid from the existing wastewater treatment unit to the infiltration/evaporation wastewater treatment lagoon.

In some embodiments, a method for constructing a wastewater treatment system is disclosed. The method includes constructing a wastewater treatment unit, constructing a wastewater treatment lagoon at a higher elevation than and proximate the wastewater treatment unit, fluidly connecting the wastewater treatment unit to the wastewater treatment lagoon, and providing a fluid pump capable of transporting fluid from the wastewater treatment unit to the wastewater treatment lagoon.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 shows a cross-sectional view of a wastewater treatment system as disclosed herein.

FIG. 2 shows a flow chart illustrating the steps of constructing a wastewater treatment system as disclosed herein.

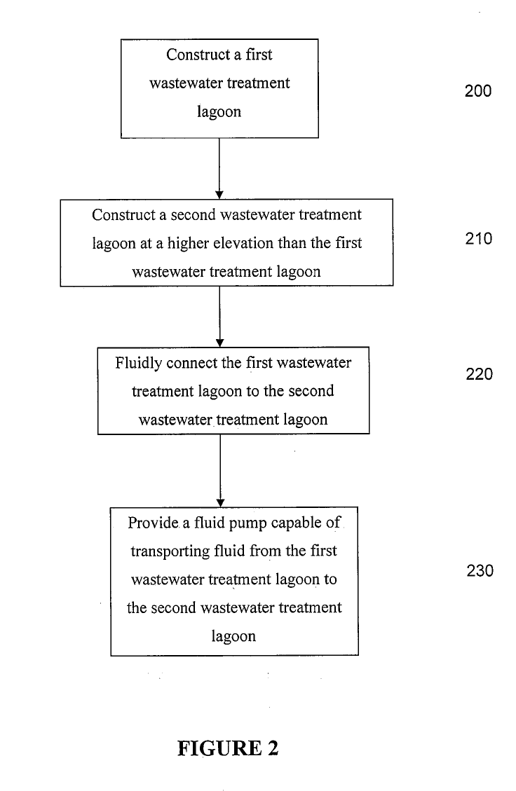

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION

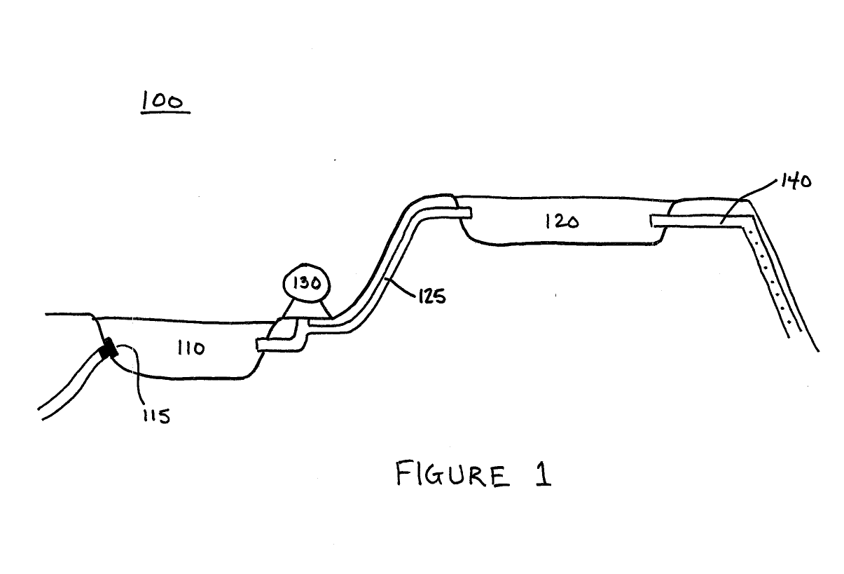

With reference to FIG. 1, some embodiments described herein include a wastewater treatment system 100 that is capable of reducing or eliminating point discharge. The wastewater treatment system 100 includes a wastewater treatment unit 110, a wastewater treatment lagoon 120 in fluid communication with the wastewater treatment unit 110 and located at a higher elevation than the wastewater treatment unit 11n, a fluid pump 110 capable of transporting fluid from the wastewater treatment unit 110 to the wastewater treatment lagoon 120, and a drip irrigation system 140 located around the periphery of the wastewater treatment lagoon 120 and in fluid communication with the wastewater treatment lagoon 120.

The wastewater treatment unit 110 of the wastewater treatment system 100 can be any type of wastewater treatment unit suitable for holding and treating wastewater. In some embodiments, the wastewater treatment unit 110 is a wastewater treatment lagoon. Suitable wastewater treatment lagoons for use as the wastewater treatment unit 110 in the wastewater treatment system 100 include, but are not limited to, aerobic lagoons, anaerobic lagoons, facultative lagoons, oxidation lagoons, stabilization lagoons, polishing lagoons, and aerated lagoons. In some embodiments, the wastewater treatment unit 110 is a mechanical plant, such as mechanical plant including aeration and concrete tanks. Generally speaking, the wastewater treatment unit 110 is used to carry out at least a partial treatment of the wastewater, such as by removing at least a portion of the waste material included in the wastewater.

The wastewater treatment unit 110 can be any size necessary to handle the wastewater that is transported to the wastewater treatment system 100. The wastewater treatment unit can also include several wastewater treatment units that are fluidly connected to one another, such as in series or in parallel. A degree of wastewater treatment can be carried in out in each unit.

In embodiments where the wastewater treatment unit 110 is a wastewater treatment lagoon, the wastewater treatment lagoon is lined with a non-permeable material such that wastewater contained therein does not seep into the ground and possibly contaminate the ground water. Any type of non-permeable material can be used to line the wastewater treatment lagoon, including concrete and certain non-permeable plastic materials.

In some embodiments, the first wastewater treatment unit 110 is an existing wastewater treatment unit that is being used or has previously been used by a municipality for treating wastewater. Such existing wastewater treatment units 110 can include one or more point discharge outlets for disposing of sufficiently treated wastewater into an existing natural water source. The point discharge outlets typically transport fluid from the wastewater treatment unit to a stream, river, or the like, where the fluid is deposited into the natural water source. In some embodiments, any point discharge outlets in the wastewater treatment unit are blocked off 115 so that no point discharge occurs and all fluid from the wastewater treatment unit is diverted towards the wastewater treatment lagoon 120 described in further detail below. In some embodiments, the point discharge outlets are partially blocked or some point discharge outlets are blocked while others remain unblocked. In such embodiments, some point discharge can occur, but at a reduced amount. This reduced amount of point discharge may result in the wastewater treatment system 100 becoming compliant with point discharge regulations.

With continuing reference to FIG. 1, the wastewater treatment lagoon 120 of the wastewater treatment system 100 is located proximate the wastewater treatment unit 110 and is fluidly connected with the wastewater treatment unit 110 such that fluid can travel between the wastewater treatment unit 110 and the wastewater treatment lagoon 120. As with the wastewater treatment unit 110, the wastewater treatment lagoon 120 can have any size and shape. In some embodiments, the size of the wastewater treatment lagoon 120 is designed to be capable of sufficiently handling, treating, and disposing of the amount of wastewater being transported to the wastewater treatment system 100 and being transported from the wastewater treatment unit 110 to the wastewater treatment lagoon 120 without having an overflow of either the wastewater treatment unit 110 or the wastewater treatment lagoon 120.

In some embodiments, the wastewater treatment lagoon 120 is located at an elevation higher than the wastewater treatment unit 110. The wastewater treatment lagoon 120 is higher in many cases because the wastewater treatment unit 110 would have been previously established at the lowest available location. The wastewater treatment lagoon 120 can, for example, be constructed on top of a hill or knoll located nearby the wastewater treatment unit 110. As mentioned above, such a configuration will often be available when the wastewater treatment system 100 is constructed using an existing wastewater treatment unit as the wastewater treatment unit 110, as initial wastewater treatment units are typically constructed at the lowest available elevations.

Constructing the wastewater treatment lagoon 120 at a higher elevation than the wastewater treatment unit 110 can be advantageous for several reasons. For example, drip irrigation systems constructed around the periphery of the wastewater treatment lagoon 120 can utilize gravity to transport fluid from the wastewater lagoon 120 to the area surrounding the wastewater lagoon 120. Additionally, wastewater treatment lagoons at higher elevations can provide greater separation from groundwater, thereby reducing the risk of escaped lagoon wastewater contaminating the groundwater.

In some cases, the wastewater treatment lagoon 120 may be located at the same or lower elevation than the wastewater treatment unit 110. In such instances, the wastewater could be transported between the wastewater treatment unit 110 and the wastewater treatment lagoon 120 by gravity flow, or the wastewater might still need to be pumped to the wastewater treatment lagoon 120, such as in the case of a berm or the like existing between the wastewater treatment unit 110 and the wastewater treatment lagoon 120.

While various types of wastewater treatment lagoons can serve as the wastewater treatment lagoon 120, in some embodiments the wastewater treatment lagoon 120 is specifically a combination evaporation/infiltration wastewater treatment lagoon. Evaporation/infiltration wastewater treatment lagoons provide for the separation of constituents from wastewater both by allowing water to evaporate off the top of the lagoon and by allowing water with constituents to infiltrate into the ground below the lagoon. In the case of evaporation, the constituents are separated from the water because the constituents do not vaporize. In the case of infiltration, the constituents are treated by physical, chemical and biological reactions with sub-soils (i.e., the ground acts like a natural filter and treatment media).

The evaporation/infiltration wastewater treatment lagoon can be useful for its ability to reduce or eliminate the need for point discharge. As described above, constituents are treated or separated from water in the evaporation/infiltration wastewater treatment lagoon by evaporation and infiltration. As such, the need for discharging any of the water in the evaporation/infiltration lagoon by transporting the effluent water to a natural water source for mixing can be reduced or eliminated. Accordingly, in some embodiments, the evaporation/infiltration wastewater treatment lagoon is free of point discharge outlets that would typically allow for the transportation of effluent water out of the lagoon and to surface waters.

Additionally, an evaporation/infiltration wastewater treatment lagoon also can do away with certain wastewater treatment steps. For example, evaporation/infiltration wastewater treatment lagoons may not need or require chlorine treatment steps, as the sub-soils can naturally serve the same function. Accordingly, water leaving the evaporation/infiltration ground through the infiltration mechanism can be treated naturally as it passes through the ground and is exposed to certain soil types.

In some embodiments, the evaporation/infiltration wastewater treatment lagoon is free of any type of impermeable barrier or liner that would typically be used to prevent fluid from seeping into the ground below the wastewater treatment lagoon. In some embodiments, the evaporation/infiltration wastewater treatment lagoon includes a semi-permeable liner that fluid can pass through. A semi-permeable liner can be used in instances where the rate of fluid infiltration into the ground below the lagoon needs to be slowed, such as when the ground beneath the wastewater treatment lagoon is a loosely packed, generally porous material that freely takes in the fluid.

As noted above, the size and shape of the wastewater treatment lagoon 120 can be selected so as to ensure that the wastewater treatment lagoon 120 is capable of handling the amount of wastewater being transported to the wastewater treatment system 100. In some embodiments, the size and/or shape of the infiltration/evaporation wastewater treatment lagoon needed to handle the wastewater transported to the wastewater treatment system 100 is calculated by taking into account the rates of evaporation, infiltration, and drip irrigation of fluid away from the lagoon. Mass balance equations known to those or ordinary skill in the art can be used in making these calculations.

In some embodiments, the wastewater treatment lagoon 120 includes one or more closable partitions. The one or more partitions can be used to close off one or more sections of the wastewater treatment lagoon 120 from the rest of the wastewater treatment lagoon 120. When the one or more partitions are open, wastewater freely travels about the entirety of the wastewater treatment lagoon. When a partition is closed, a section of the wastewater treatment lagoon is separated from the remainder of the wastewater treatment lagoon. The wastewater in the partitioned portion of the wastewater treatment lagoon can then be partially or completely removed from the partitioned area. Accordingly, maintenance can be performed on the drained partitioned area. For example, a semi-permeable liner included as part of the evaporation/infiltration wastewater treatment lagoon can be repaired or replaced. Also for example, a buildup of material on the floor of the lagoon, such as algae, can be removed from the partitioned area to ensure adequate infiltration continues to take place. Alternatively or in conjunction with the closable partitions, the wastewater treatment lagoon 120 may comprise two or more fluidly connected basins. The fluidly connected basins may be shut off from one another and fluid may be drained from any of the basins to any of the other basins so that maintenance in the drained basin can be completed.

The wastewater treatment lagoon 120 is fluidly connected to the wastewater treatment unit 110. Any suitable means for providing fluid communication between the wastewater treatment unit 110 and the wastewater treatment lagoon 120 can be used. With reference to FIG. 1, the fluid communication between the wastewater treatment unit 110 and the wastewater treatment lagoon 120 is provided by piping 125. While shown underground in FIG. 1, piping 125 may also be above ground, or the piping can include aboveground and underground sections. In some embodiments, underground piping is preferred, as it helps to prevent fluid from freezing within the piping.

A fluid pump 130 is provided as part of the wastewater treatment system 100 in order to aid the transportation of fluid from the wastewater treatment unit 110 to the wastewater treatment lagoon 120. Such assistance can be useful in embodiments such as that shown in FIG. 1, where the wastewater treatment lagoon 120 is located at an elevation higher than the wastewater treatment unit 110.

In some embodiments, the fluid pump is powered by a renewable power source. Any renewable power source capable of providing sufficient power to the fluid pump can be used. Exemplary renewable power sources include, but are not limited to, wind power and solar power. In some embodiments, a wind powered fluid pump is preferred. In some embodiments, the renewable power source is capable of storing excess power generated for use during instances when conditions are not suitable for further power generation.

In some embodiments, the renewable power source used to power the fluid pump includes a back-up power source. The back-up power source can be a renewable power source, a non-renewable power source, or a combination of both. For instance, when the fluid pump is primarily powered by wind power, the fluid pump can also include both a solar back-up power source and an electric back-up power source. The back-up power source can be useful to avoid instances where the fluid pump needs to be operated in order to prevent wastewater overflow in the wastewater treatment unit 110 but when conditions are not favorable to generate power to operate the fluid pump via the non-renewable power source.

Wastewater treatment system 100 can also include a drip irrigation system 140. Drip irrigation system 140 can be located around the periphery of the wastewater treatment lagoon 120. Drip irrigation system 140 can be any type of drip irrigation system that is suitable for providing fluid to the area surrounding the wastewater treatment lagoon 120. The source of fluid for drip irrigation system 140 is fluid contained in the wastewater treatment lagoon 120. Accordingly, drip irrigation system 140 can be in fluid communication with the wastewater treatment lagoon 120. Drip irrigation system 140 provides another use and treatment method for the fluid in the wastewater treatment system 100. Soils in the area around the wastewater treatment lagoon 120 can treat constituents by physical, chemical and biological reactions with soils. Vegetation in the area surrounding the wastewater treatment lagoon 120 can absorb fluid provided by the drip irrigation system 140, thereby depleting the amount of fluid contained in the wastewater treatment lagoon 120 and allowing for additional wastewater from the wastewater treatment unit 110 to be transported to and treated by the wastewater treatment lagoon 120.

In some embodiments, a method of constructing a wastewater treatment system generally includes a step 200 of constructing a wastewater treatment unit, a step 210 of constructing a wastewater treatment lagoon that is proximate the wastewater treatment unit and located at a higher elevation than the wastewater treatment unit, a step 220 of fluidly connecting the wastewater treatment unit to the wastewater treatment lagoon, and a step 230 of providing a fluid pump capable of transporting fluid from the wastewater treatment unit to the wastewater treatment lagoon.

The wastewater treatment unit and the wastewater treatment lagoon constructed in steps 200 and 210 can be similar or identical to the wastewater treatment unit and wastewater treatment lagoon described in greater detail above. As discussed above, in some embodiments the wastewater treatment lagoon is a combined evaporation/infiltration lagoon, and the wastewater treatment lagoon can include one or more closable partitions for use in conducting maintenance on the wastewater treatment lagoon.

As also discussed above, any suitable means of fluidly connecting the wastewater treatment unit to the wastewater treatment lagoon in step 220 can be used, such as by providing piping that connects the wastewater treatment unit to the wastewater treatment lagoon and allows fluid to travel between the wastewater treatment unit and the wastewater treatment lagoon.

The fluid pump provided in step 230 can be similar or identical to the fluid pump described in greater detail above. The fluid pump provided should be capable of transporting fluid from the wastewater treatment unit to the wastewater treatment lagoon. In some embodiments, the fluid pump is powered by a renewable power source, such as wind power or solar power. The fluid pump can also include a back-up power source, including a non-renewable power source.

In some embodiments, the method further includes a step of constructing a drip irrigation system around the periphery of and in fluid communication with the wastewater treatment lagoon. The drip irrigation system constructed can be similar or identical to the drip irrigation system described in greater detail above.

In some embodiments, the wastewater treatment system is constructed by utilizing an existing wastewater treatment unit. For example, many municipalities may currently be operating an existing wastewater treatment unit. In some instances, the existing wastewater treatment unit will include point discharge of treated fluid into natural surface water. Such point discharge can be reduced or eliminated by constructing an evaporation/infiltration wastewater treatment lagoon in the proximity of the existing wastewater treatment unit and at a higher elevation than the existing wastewater treatment unit. The existing wastewater treatment unit and the evaporation/infiltration wastewater lagoon can then be fluidly connected such that fluid from the existing wastewater treatment unit is partially or wholly diverted to the evaporation/infiltration wastewater treatment lagoon rather than to a point discharge. A fluid pump can be provided to assist in transporting fluid between the existing wastewater treatment unit and the evaporation/infiltration wastewater treatment lagoon. To facilitate movement of fluid to the evaporation/infiltration wastewater treatment lagoon, one or more point discharge outlets provided in the existing wastewater treatment unit can be partially or wholly blocked. Additionally, a drip irrigation system can be constructed around the periphery of the evaporation/infiltration system to provide another use and treatment method for fluid contained in the evaporation/infiltration system.

The existing wastewater treatment unit, the evaporation/infiltration wastewater treatment lagoon, the fluid communication supplied between the existing wastewater treatment unit and the evaporation/infiltration wastewater treatment lagoon, the fluid pump, and the drip irrigation system can each be similar or identical to the corresponding components of the wastewater treatment system described in greater detail above.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “a” or “an,” as used in the specification and claims, are to be construed as meaning “at least one of.” In addition, for ease of use, the words “including” and “having,” as used in the specification and claims, are interchangeable with and have the same meaning as the word “comprising.”

What is claimed is:

1. A wastewater treatment system comprising:
a wastewater treatment unit;
a wastewater treatment lagoon in fluid communication with the wastewater treatment unit and located at a higher elevation than the wastewater treatment unit; and
a fluid pump capable of transporting fluid from the wastewater treatment unit to the wastewater treatment lagoon.

2. The wastewater treatment system, further comprising:
a drip irrigation system located around the periphery of the wastewater treatment lagoon and in fluid communication with the wastewater treatment lagoon.

3. The wastewater treatment system as recited in claim 1, wherein the wastewater treatment lagoon comprises an infiltration/evaporation wastewater treatment lagoon.

4. The wastewater treatment system as recited in claim 3, wherein the infiltration/evaporation wastewater treatment lagoon is lined with a semi-permeable layer for modifying the wastewater infiltration rate.

5. The wastewater treatment system as recited in claim 1, wherein the wastewater treatment lagoon is free of point discharge outlets.

6. The wastewater treatment system as recited in claim 1, wherein the fluid pump is powered by a renewable energy source

7. The wastewater treatment system as recited in claim 6, wherein the renewable energy source comprises wind-power.

8. The wastewater treatment system as recited in claim 6, wherein the fluid pump includes a back-up power source.

9. The wastewater treatment system as recited in claim 3, wherein the infiltration/evaporation wastewater treatment system comprises one or more closable partitions.

10. A method of modifying a wastewater treatment system comprising:
constructing an infiltration/evaporation wastewater treatment lagoon in the proximity of and at a higher elevation than an existing wastewater treatment unit;
fluidly connecting the infiltration/evaporation wastewater treatment lagoon to the existing wastewater treatment unit; and
providing a fluid pump capable of transporting fluid from the existing wastewater treatment unit to the infiltration/evaporation wastewater treatment lagoon.

11. The method as recited in claim 10, wherein the existing wastewater treatment unit comprises one or more point discharge outlets and wherein the method further comprises partially or wholly blocking off at least one of the one or more point discharge outlets.

12. The method as recited in claim 10, further comprising the step of constructing a drip irrigation system around the periphery of the infiltration/evaporation wastewater treatment lagoon and fluidly connecting the infiltration/evaporation wastewater treatment lagoon with the drip irrigation system.

13. The method as recited in claim 10, wherein constructing the infiltration/evaporation wastewater treatment lagoon includes lining the infiltration/evaporation wastewater treatment lagoon with a semi-permeable layer for modifying the wastewater infiltration rate.

14. The method as recited in claim 10, wherein the fluid pump comprises is powered by a renewable energy source.

15. The method as recited in claim 14, wherein the renewable energy source comprises wind power

16. The method as recited in claim 14, wherein the fluid pump includes a back-up power source.

17. The method as recited in claim 10, wherein constructing the infiltration/evaporation wastewater treatment lagoon includes constructing one or more closable partitions within the infiltration/evaporation wastewater treatment lagoon.

18. A method for constructing a wastewater treatment system comprising:
constructing a wastewater treatment unit;
constructing a wastewater treatment lagoon at a higher elevation than and proximate the wastewater treatment unit;
fluidly connecting the wastewater treatment unit to the wastewater treatment lagoon; and
providing a fluid pump capable of transporting fluid from the wastewater treatment unit to the wastewater treatment lagoon.

19. The method as recited in claim 18, further comprising the step of constructing a drip irrigation system around the periphery of the wastewater treatment lagoon and in fluid communication with the wastewater treatment lagoon.

20. The method as recited in claim 18, wherein the wastewater treatment lagoon is an infiltration/evaporation wastewater treatment lagoon.

21. The method as recited in claim 18, wherein the fluid pump is powered by a renewable energy source.

22. The method as recited in claim 21, wherein the renewable energy source is wind power.

23. The method as recited in claim 21, wherein the fluid pump includes a back-up power source.

24. The method as recited in claim 18, wherein constructing the wastewater treatment lagoon includes constructing one or more closable partitions within the wastewater treatment lagoon.
